(19) United States
(12) Patent Application Publication
(10) Pub. No.: US 2021/0194120 A1
(43) Pub. Date: Jun. 24, 2021

(54) HOLDER WITH COUNTERWEIGHT STRUCTURE AND FOR MOUNTING ON ANTENNA

(71) Applicant: ZHONGYUAN INNOVATION CO., LTD., Foshan, Guangdong (CN)

(72) Inventor: Weiqiang ZHANG, Foshan, Guangdong (CN)

(21) Appl. No.: 16/075,989

(22) PCT Filed: Jan. 6, 2017
(86) PCT No.: PCT/CN2017/070361

§ 371 Date: Aug. 7, 2018

(30) Foreign Application Priority Data
Dec. 26, 2016 (CN) 201621437052.6

(51) Int. Cl. H01Q 1/48; H01Q 1/22; H01Q 3/06

(52) U.S. Cl. CPC H01Q 1/48; H01Q 3/06; H01Q 1/22

(57) ABSTRACT

A holder with a counterweight structure and for mounting on an antenna comprises a fixing seat, a rotating seat, a rotor, two plug caps, a connecting piece and a weight part; wherein the fixing seat is formed with a rotor mounting portion; the rotor mounting portion includes two rotor mounting holes extending in a rotational axis direction at both ends thereof, a cavity into which a counterweight is placed, and a counterweight cover for covering a cavity opening; the rotor mounting hole is formed with a hexagonal connecting post disposed at an inner bottom surface thereof and extending in the rotational axis direction; the hexagonal connecting post has an annular limiting boss; wherein the rotating seat includes two rotor sleeves disposed symmetrically with each other; the rotor mounting portion coincides with the axis of rotation of the two rotor sleeves and is connected therebetween.

### BACKGROUND OF INVENTION

### 1. Field of the Invention

The present invention relates to a technical field of an antenna mounting holder, particularly to a holder with a counterweight structure and for mounting on an antenna.

### 2. Description of Related Art

At present, the TV antenna module is not provided with a specific bracket for fixing, and it is mainly fixed by a simple bracket structure, which often causes the antenna module to fall off due to poor stability and thus causes damage. Secondly, the antenna module fixed by a simple bracket is difficult to adjust the bracket structure. When the antenna module needs to be adjusted in position, the antenna module can only be repositioned in a reassembled way to make position adjustment, and the operation process is complicated. In addition, the simple bracket structure can not be applied to larger antenna module, so its stability is poor.

### SUMMARY OF THE INVENTION

The object of the present invention is to overcome the deficiencies of the prior art, and to provide a convenient and fast adjustment and stability with a holder with counterweight structure and for mounting on an antenna. In order to achieve the above object, the present invention provide a holder with a counterweight structure and for mounting on an antenna comprising

a fixing seat, a rotating sea, a rotor, two plug caps, a connecting piece and a weight part; wherein the fixing seat is formed with a rotor mounting portion; the rotor mounting portion includes two rotor mounting holes extending in a rotational axis direction at both ends thereof, a cavity into which a counterweight is placed, and a counterweight cover for covering a cavity opening; the rotor mounting hole is formed with a hexagonal connecting post disposed at an inner bottom surface thereof and extending in the rotational axis direction; the hexagonal connecting post has an annular limiting boss; wherein the rotating seat includes two rotor sleeves disposed symmetrically with each other; the rotor mounting portion coincides with the axis of rotation of the two rotor sleeves and is connected therebetween; the each rotor sleeve has a plurality of annularly distributed internal teeth disposed on the inner side thereof; the rotating seat is formed with a clamping structure for engaging with a slot on the weight part; wherein the rotor is opened with a connecting groove disposed at one end thereof and connected with the hexagonal connecting post, and another end thereof has four circumferentially distributed notches so as to form four rotating rods; the each rotating rod includes external teeth meshing with internal teeth disposed on the inner side of the rotor sleeve; wherein the two plug caps cover outer sides of the two rotor sleeves respectively, and an outer side of one end of the plug cap is engaged with an inner side of the rotor sleeve.

More particularly, wherein the rotating seat includes at least one mounting hole.

More particularly, wherein the weight part includes a weight block disposed therein.

More particularly, wherein the length of the fixing seat is 800˜900 mm.

The present invention adopts the above-mentioned solution, and has the beneficial effects that the two ends of the rotor are respectively coupled with the rotor mounting hole and the rotor sleeve, thereby realizing the rotational connection between the fixing seat and the rotating seat. When the fixing seat is rotated, the rotation of the rotor is driven by the hexagonal connecting post, and the external teeth jump into the other tooth grooves of the internal teeth due to the elastic deformation between the rotating pieces on the rotor until the appropriate position is adjusted, the external teeth cooperating with the internal teeth to form a self-locking state, thereby realizing the position adjustment of the antenna module; in addition, the stability of the holder is enhanced by providing counterweights on the fixing seat and the rotating seat. Through the above scheme, the holder has the characteristics of convenient adjustment, good stability and the like.

### BRIEF DESCRIPTION OF THE DRAWINGS

FIG. 1 is a schematic structural view of a holder according to the present invention;

FIG. 2 is an exploded view of the holder;

FIG. 3 is a side view of the holder without plug caps according to the present invention;

FIG. 4 is a partial enlarged view of A in FIG. 3;

FIG. 5 is a side view of a fixing seat of the present invention.

### DETAILED DESCRIPTION OF THE INVENTION

The present invention will be further described below in combination with specific embodiments.

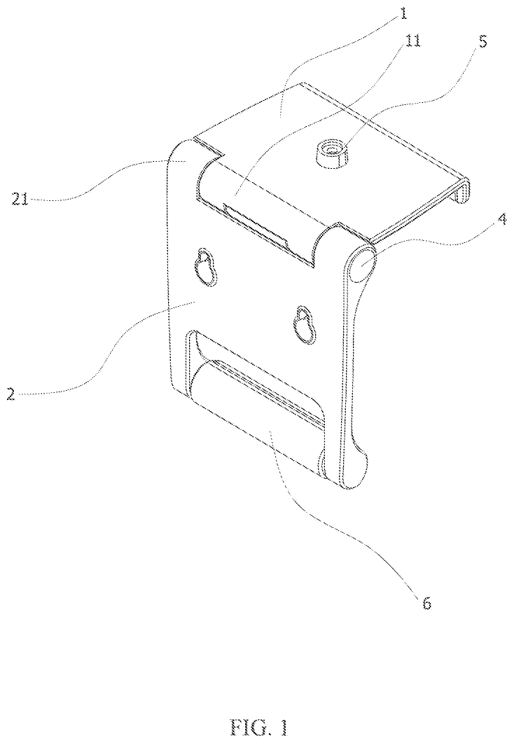

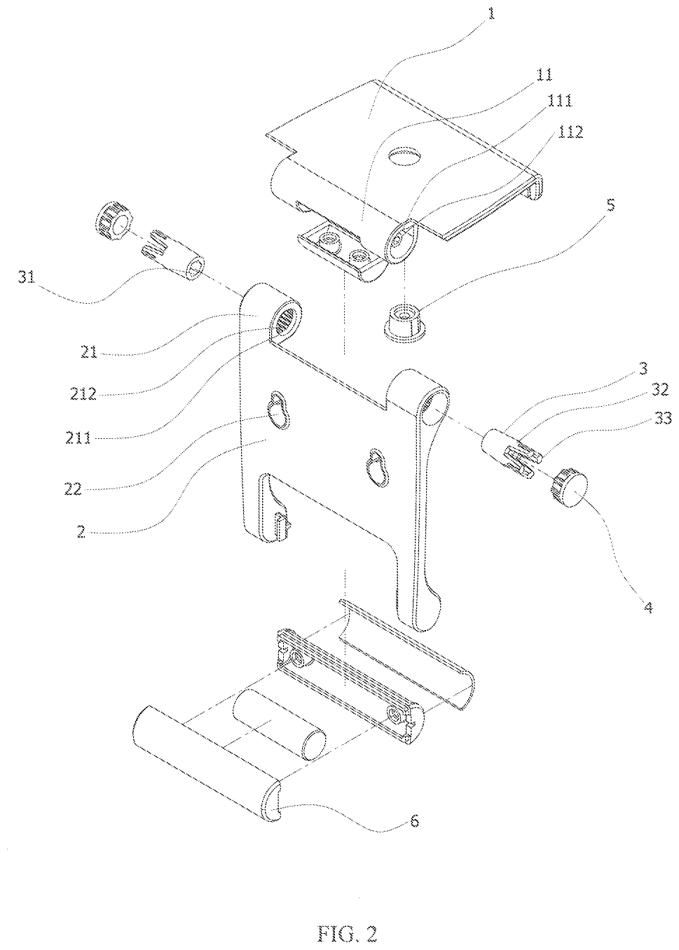

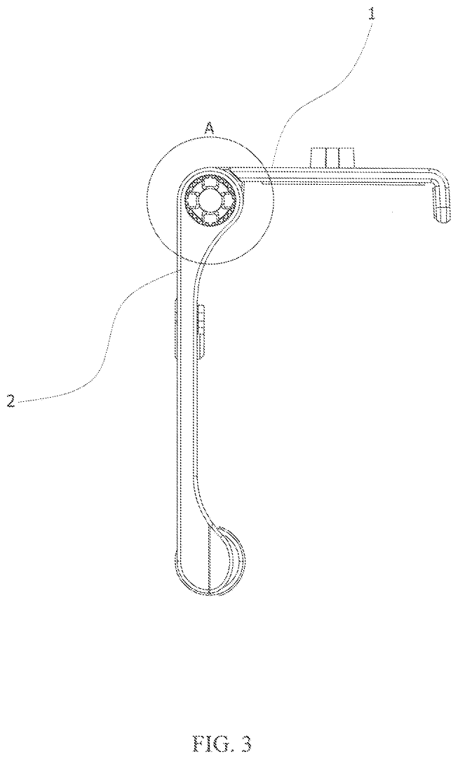

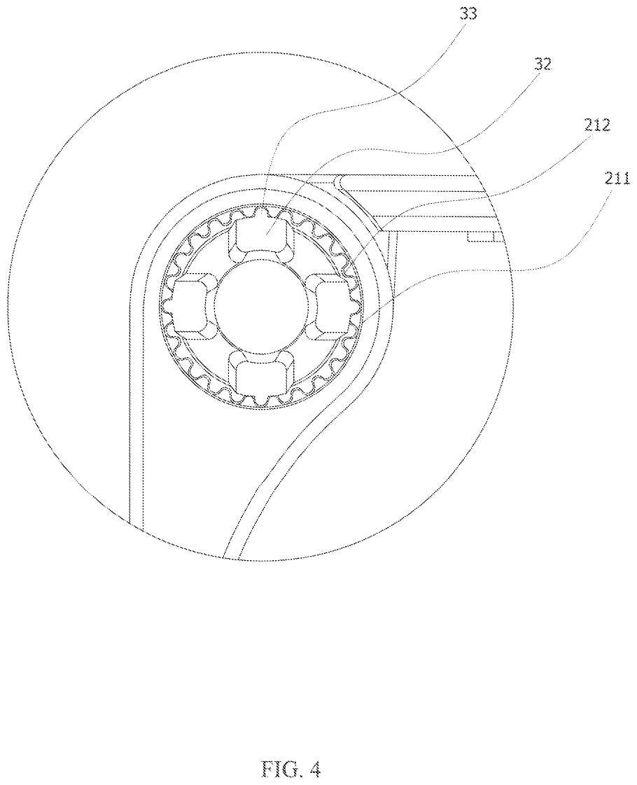

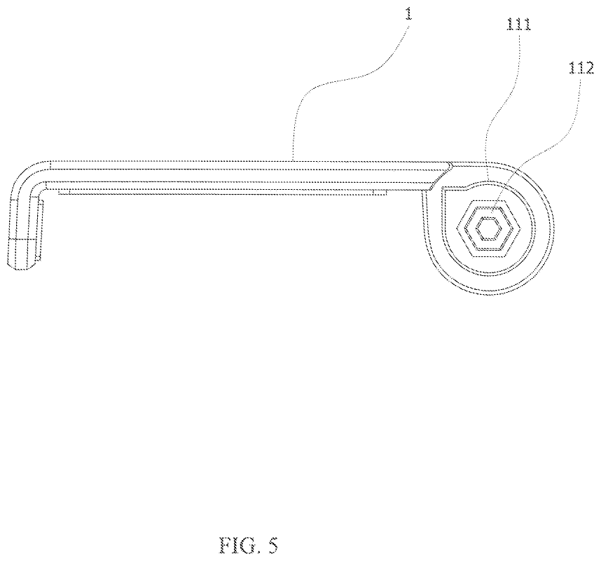

Referring to FIG. 1 to FIG. 5, in this embodiment, a holder with a counterweight structure and for mounting on an antenna comprises a fixing seat (1), a rotating seat (2), a rotor (3), two plug caps (4), a connecting piece (5) and a weight part (6). The length of the fixing seat (1) is 800˜900 mm, so that the hanging seat is suitable for a large-sized antenna module. The holder is a plastic parts. The fixing seat (1) is formed with a rotor mounting portion (11). The rotor mounting portion (11) has two rotor mounting holes (111) extending in a rotational axis direction at both ends thereof, a cavity into which a counterweight is placed, and a counterweight cover for covering a cavity opening. Secondly, the rotor mounting hole (111) is internally deplasticized to prevent the occurrence of shrinkage; the rotor mounting hole (111) is formed with a hexagonal connecting post (112) disposed at an inner bottom surface thereof and extending in the rotational axis direction; the hexagonal connecting post (112) has an annular limiting boss for increasing the strength thereof. The fixing seat (1) has a through hole for allowing the connecting piece (5) to pass therethrough and connect the antenna main body, so that the antenna module can be firmly connected with the fixing seat (1) in this way. The rotating seat (2) includes two rotor sleeves (21). The rotor mounting portion (11) coincides with the axis of rotation of the two rotor sleeves (21) and is connected therebetween. The each rotor sleeve (21) has a plurality of annularly distributed internal teeth (211) disposed on the inner side thereof; the rotating seat (2) is formed with a clamping structure for engaging with a slot on the weight part (6); wherein, in order to prevent the weight part (6) from being installed in the reverse direction, a positioning block is provided on the clamping structure; by providing the weight part (6), the stability of the rotating seat (2) is enhanced. In addition, the rotating seat (2) includes two mounting holes (22), by which the the rotating seat (2) can be attached to various positions. The two plug caps (4) cover outer sides of the two rotor sleeves (21) respectively, and an outer side of one end of the plug cap (4) is matched with an inner side of the rotor sleeve (21); wherein the plug cap (4) includes a ring of stiffener disposed on the outer side thereof; the stiffener and the rotor sleeve (21) are engaged together in an interference fitted connection, so that the plug cap (4) can be more tightly covered on the rotor sleeve (21). The rotor (3) is opened with a connecting groove (31) disposed at one end thereof and connected with the hexagonal connecting post (112), and another end thereof has four circumferentially distributed notches so as to form four rotating rods (32), wherein each rotating rod (32) includes external teeth (33) meshing with internal teeth (211) disposed on the inner side of the rotor sleeve (21). The fixing seat (1) and the rotating seat (2) are connected by both ends of the rotor (3) respectively engaging with the rotor mounting holes (111) and the rotor sleeve (21). When the fixing seat (1) is rotated, the fixing seat (1) drives the rotor (3) to rotate through the hexagonal connecting post (112), and the four rotating rods (32) at the other end of the rotor (3) are elastically deformed under the action of the torque, so that the external teeth (33) jump into internal slots of the other internal teeth (211) until the proper position is reached and the rotation of the fixing seat (1) is stopped, the external teeth (33) and the internal teeth (211) form a self-locking state, thereby completing the position adjustment. Through the adjustment in the above manner, the adjustment of the holder is simpler and faster, and the stability is increased. In addition, silicone rubber is placed in contact with the antenna module to achieve anti-slip and anti-wear effects.

The above only describes some exemplary embodiments of the present invention. Those having ordinary skills in the art may also make many modifications and improvements without departing from the conception of the invention, which shall all fall within the protection scope of the invention.

I claim:

1. A holder with a counterweight structure and for mounting on an antenna comprising
a fixing seat (1), a rotating seat (2), a rotor (3), two plug caps (4), a connecting piece (5) and a weight part (6);
wherein the fixing seat (1) is formed with a rotor mounting portion (11); the rotor mounting portion (11) includes two rotor mounting holes (111) extending in a rotational axis direction at both ends thereof a cavity into which a counterweight is placed, and a counterweight cover for covering a cavity opening; the rotor mounting hole (111) is formed with a hexagonal connecting post (112) disposed at an inner bottom surface thereof and extending in the rotational axis direction; the hexagonal connecting post (112) has an annular limiting boss;
wherein the rotating seat (2) includes two rotor sleeves (21) disposed symmetrically with each other; the rotor mounting portion (11) coincides with the axis of rotation of the two rotor sleeves (21) and is connected therebetween; the each rotor sleeve (21) has a plurality of annularly distributed internal teeth (211) disposed on the inner side thereof; the rotating seat (2) is formed with a clamping structure for engaging with a slot on the weight part (6);
wherein the rotor (3) is opened with a connecting groove (31) disposed at one end thereof and connected with the hexagonal connecting post (112), and another end thereof has four circumferentially distributed notches so as to form four rotating rods (32); the each rotating rod (32) includes external teeth (33) meshing with internal teeth (211) disposed on the inner side of the rotor sleeve (21);
wherein the two plug caps (4) cover outer sides of the two rotor sleeves (21) respectively, and an outer side of one end of the plug cap (4) is engaged with an inner side of the rotor sleeve (21).

2. The holder with the counterweight structure and for mounting on the antenna according to claim 1, wherein the rotating seat (2) includes at least one mounting hole (22).

3. The holder with the counterweight structure and for mounting on the antenna according to claim 1, wherein the weight part (6) includes a weight block disposed therein.

4. The holder with the counterweight structure and for mounting on the antenna according to claim 1, wherein the length of the fixing seat (1) is 800˜900 mm.
